(19) United States
(12) Patent Application Publication
(10) Pub. No.: US 2014/0173409 A1
(43) Pub. Date: Jun. 19, 2014

(54) PICTURE PROCESSING SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: Xin GUO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/097,255

(22) Filed: Dec. 5, 2013

(30) Foreign Application Priority Data
Dec. 18, 2012 (CN) 201210549060X

(51) Int. Cl. G06F 17/24

(52) U.S. Cl. CPC G06F 17/241
USPC 715/232

(57) ABSTRACT

A method for processing pictures comprises steps. Generate a request signal for adding annotation information about the picture in response to an input operation to a displayed picture. Generate an input box and display the input box on the displayed picture to allow user to input annotation information. Recognize the annotation information input in the input box. Determine a position the annotation information labeled. Generate a mark to mark the position and display the mark on the position. Establish a relationship between the picture, the annotation information, the position of the annotation information, and the mark. Store the generated relationship. Generate a request signal for browsing annotation information about the picture in response to a input operation. Obtain the annotation information of the picture. Display the obtained annotation information of the picture.

### BACKGROUND

1. Technical Field

The present disclosure relates to pictures processing, and particularly to an picture processing system and method for processing pictures.

2. Description of Related Art

Generally, picture display devices permit browsing of displayed pictures or getting of information from the pictures such as name of a picture, size of a picture, the picture taking time and the last amendment time of a picture. However, more information cannot be visually received about the displayed pictures by simply browsing those pictures, such as a story related to the picture.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block view of a picture processing system, in accordance to an exemplary embodiment of the present disclosure.

FIG. 2 is a flowchart of a method for processing pictures, in accordance to an exemplary embodiment of the present disclosure.

### DETAILED DESCRIPTION

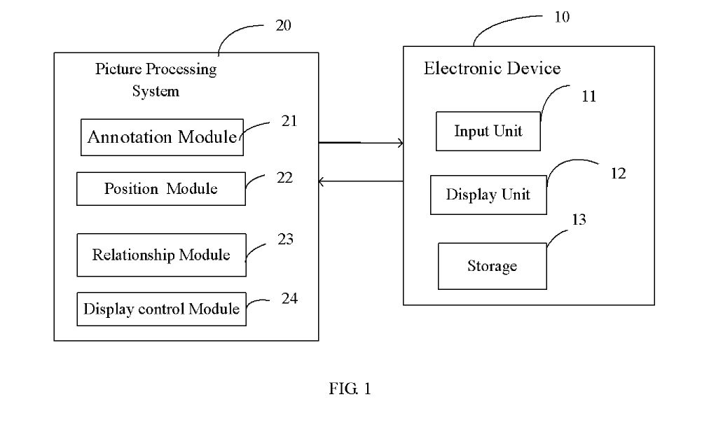

FIG. 1 shows that a picture processing system 20 is applied to an electronic device 10. The electronic device 10 includes an input unit 11, a display unit 12 and a storage unit 13. The storage unit 13 is configured to store a number of pictures. The picture processing system 20 is configured to allow users to add annotation information to the pictures and control the display unit 12 to display the annotation information in response to manual operations, so that the annotation information about the picture can be obtained.

The input unit 11 is configured to generate manipulation signals in response to manual operations. In the embodiment, the input unit 11 generates a request signal for displaying a selected picture by the display unit 12 in response to a first input operation, generates a request signal for adding annotation information in response to a second input operation, and generates a request signal of browsing the annotation information in response to a third input operation. The input unit 11 is further configured to transmit the generated manipulation signals to the picture processing system 20.

The picture processing system 20 includes an annotation module 21, a position module 22, a relationship module 23 and a display control module 24.

The display control module 24 is configured to control the display unit 12 to display contents in response to the manipulation signals generated by the input unit 11. In the embodiment, the display control module 24 controls the display unit 12 to display a selected picture when the input unit 11 generates a request signal to display the selected picture stored in the storage unit 13 in response to a first input operation applied to the input unit 11. The display control module 24 controls the display unit 12 to display an input box on the picture to allow user to input annotation information in response to a second input operation applied to the input unit 11. The display control module 24 controls the display unit 12 to display the annotation information of the displayed picture in response to a third input operation applied to the input unit 11.

In the illustrated embodiment, the input unit 11 is configured to generate a request signal of adding annotation information about the picture in response to a second input operation such as clicking the mouse double on a displayed picture. In another embodiment, the input unit 11 is configured to generate a request signal of adding annotation information about the picture in response to a second input operation such as clicking a particular icon provided for activating the generation of a request signal of adding annotation information about a picture.

The annotation module 21 is configured to generate an input box to allow the user to input annotation information in response to the request signal of adding annotation information and recognize the annotation information in the input box input by the user. In the embodiment, the input box can be displayable at any area of the displayed picture. The size of the input box is changeable by the user. The shape of the input box may be a rectangle, or a ring, for example. The annotation information includes text messages, pictures, or links, for example. The input box and the annotation information are transparent or semitransparent so that the picture displayed on the display unit 12 is visible through the input box.

The position module 22 is configured to determine a position of the annotation information input through the input box in relation to the picture and generate a mark to label the determined position and further display the mark. In the embodiment, the mark corresponds to the position of the annotation information. Thus, when the picture is enlarged, the mark is also enlarged and still marks the position of the corresponding annotation information. In the embodiment, the position module 22 determines the position of the annotation information by detecting the position of a cursor on the picture or a position of the input box the user moves to. The position of the input box may be represented by the position of a corner of the input box, or the position of the center point of the input box. The position module 22 is configured to store the generated mark to the storage unit 13.

The relationship module 23 is configured to establish a relationship between the picture, the annotation information of the picture, the position of the annotation information, and the mark marking the position. The relationship further records basic information of the picture, such as the format of the picture, the size of the picture, the taking time of the picture and the name of the picture. The relationship module 23 is configured to store the established relationship to the storage unit 13

After the user annotates a picture, the picture processing system 20 allows the user to browse the annotation information of the picture.

The display control module 24 is configured to obtain the annotation information of the picture when the input unit 11 generates a request signal of browsing the annotation information in response to a third input operation such as clicking a particular icon provided for activating the generation of a request signal of browsing the annotation of the information and control the display unit 12 to display the obtained annotation information of the picture. In the embodiment, the display control module 24 obtains the annotation information from the stored relationship. The annotation information of the picture is displayed in a transparent or semitransparent way without hiding any part of the picture displayed on the display unit.

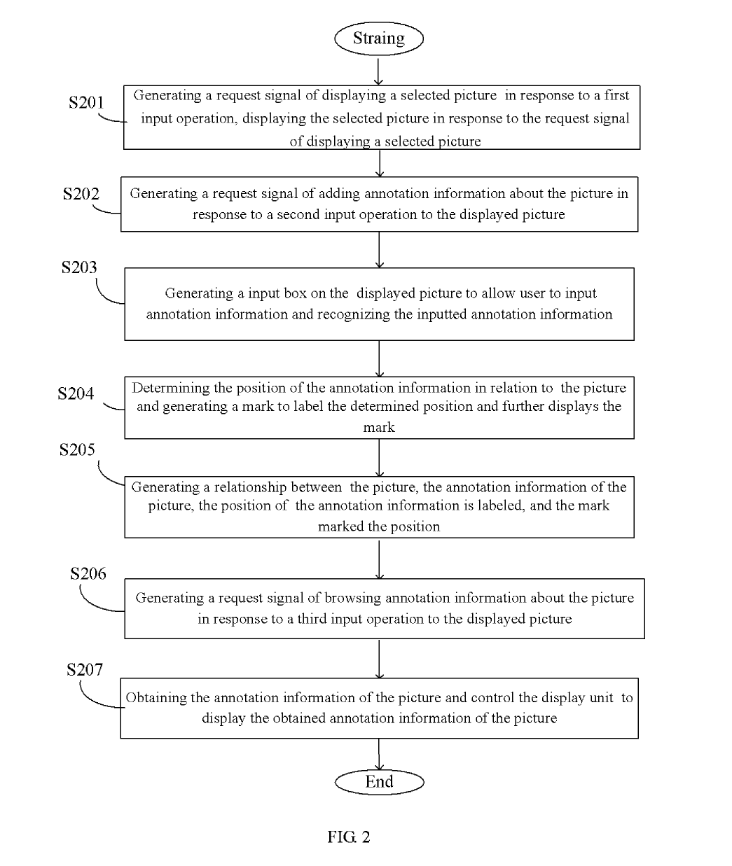

FIG. 2 shows a flowchart of a method for processing the picture. The method includes following steps:

In step S201: the input unit 11 generates a request signal of displaying a selected picture on the display unit 12 in response to a first input operation, the display unit 12 displays the selected picture in response to the request signal of displaying a selected picture.

In step S202: the input unit 11 generates a request signal of adding annotation information about the selected picture in response to a second input operation to the displayed picture.

In step S203: the annotation module 21 displays an input box on the displayed picture to allow the user to input annotation information and recognizes the input annotation information in the input box.

In the embodiment, the input box can be displayable at any area of the displayed picture. The size of the input box is changeable by the user. The shape of the input box may be a rectangle, or a ring, for example. The annotation information includes text messages, pictures, or links for example. The input box and the annotation information are transparent or semitransparent so that the picture displayed on the display unit 12 is visible through the input box.

In step S204: the position module 22 determines the position of the annotation information in relation to the picture and generates a mark to label the determined position and further displays the mark. The position module 22 determines the position of the annotation information by detecting the position of a cursor on the picture or the position of the input box.

In step S205: the relationship module 23 establishes a relationship between the picture, the annotation information of the picture, the position of the annotation information, and the mark marking the position. The relationship also records the basic information of the picture such as the format of the picture, the size of the picture, the taking time of the picture and the name of the picture.

In step S206: the input unit 11 generates a request signal of browsing annotation information about the picture in response to a third input operation to the displayed picture.

In step S207: the display control module 24 obtains the annotation information of the displayed picture and control the display unit 12 to display the obtained annotation information of the picture. In the embodiment, the display control module 24 obtains the annotation information from the stored relationship.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A picture processing system applied to an electronic device, the electronic device comprising an input unit, a display unit, a storage unit configured to store pictures, the picture processing comprising:
an annotation module configured to generate an input box to receive annotation information input by a user in response to a request signal of adding annotation information and recognize the input annotation information in the input box;
a position module configured to determine a position of the annotation information on the picture, and generate a mark to mark the position, and further display the generated mark on the display unit;
a relationship module configured to establish a relationship among the picture, the annotation information of the picture, the position where the annotation information is located, and the mark marking the position; wherein the position module is further configured to store the mark to the storage unit, the relationship module is further configured to store the relationship to the storage unit;
a display control module configured to obtain the annotation information of the picture from the storage unit in response to a request signal for browsing annotation information of a picture and control the display unit to display the obtained annotation information of the picture;
wherein the display control module is further configured to control the display unit to display the generated input box on the picture.

2. The picture processing as described in claim 1, wherein the annotation module determines the position of the annotation information by detecting a position of a cursor on the picture the user moves to.

3. The picture processing as described in claim 1, wherein the annotation module determines the position of the annotation information by detecting a position of the input box the user moves to.

4. The picture processing as described in claim 1, wherein the input unit generates the request signal of adding annotation information in response to a second input operation applied to the displayed picture and generates the request signal of browsing the annotation information in response to a third input operation applied to the displayed picture.

5. The picture processing as described in claim 4, wherein the input box is displayable at any area of the displayed picture.

6. The picture processing as described in claim 4, wherein the size of the input box is changeable by the user.

7. The picture processing as described in claim 4, wherein the shape of the input box is a rectangle or a ring.

8. The picture processing as described in claim 1, wherein the input box and the annotation information are displayed in a transparent or semitransparent way without hiding any part of the picture displayed on the display unit.

9. The picture processing as described in claim 1, wherein the annotation information is selected from the group consisted from text messages, pictures and links.

10. A method for processing pictures, comprising:
generating a request signal for displaying a picture selected by a user in response to a first input operation and displaying the selected picture;
generating a request signal for adding annotation information about the picture in response to a second input operation to a displayed picture;
generating an input box to receive annotation information input by the user;
displaying the input box on the displayed picture to allow the user to input the annotation information;
recognizing the input annotation information in the input box;
determining a position the annotation information on the picture;
generating a mark to mark the position and displaying the generated mark on the position;
establishing a relationship between the picture, the annotation information of the picture, the position of the annotation information, and the generated mark,
storing the established relationship;
generating a request signal for browsing annotation information about the picture in response to a third input operation;
obtaining the annotation information of the picture; and
displaying the obtained annotation information of the picture.

11. The method described as in claim 10, wherein the obtained annotation information are displayed in a transparent or semitransparent way without hiding any part of the picture.

12. The method described as in claim 11, wherein the step “determining the position the annotation information on the picture” comprises determining the position of the annotation information by detecting a position of a cursor on the picture the user moves to.

13. The method described as in claim 11, wherein the step “determining the position the annotation information on the picture” comprises determining the position of the annotation information by detecting a position of the input box the user moves to.
